(19) United States
(12) Patent Application Publication
(10) Pub. No.: US 2020/0100483 A1
(43) Pub. Date: Apr. 2, 2020

(54) APPARATUS AND METHOD FOR FISHING

(71) Applicant: Matthew DeIulio, Austin, TX (US)

(72) Inventor: Matthew DeIulio, Austin, TX (US)

(21) Appl. No.: 16/567,611

(22) Filed: Sep. 11, 2019

Related U.S. Application Data
(60) Provisional application No. 62/830,274, filed on Apr. 5, 2019.
(60) Provisional application No. 62/729,904, filed on Sep. 11, 2018.

(51) Int. Cl. A01K 91/03; A01K 97/10

(52) U.S. Cl. CPC A01K 91/03; A01K 97/10

(57) ABSTRACT

Fishing accessories and methods of using fishing accessories configured to be selectively coupled with terminal tackle during a knot cinching operation.

### FIELD OF THE DISCLOSURE

The present disclosure is directed to devices and methods for fishing.

### RELATED ART

Anglers typically tie elements such as terminal tackle to fishing line or leader when fishing. Many terminal tackle include hooks having sharpened points for embedding in the mouth of a fish. Hook sharpness is very important when setting a hook in a fish's mouth. Consequently, hooks have gotten sharper and more efficient at piercing and holding on to fish. Some terminal tackle include hook arrays (e.g., treble hooks) with multiple, connected hooks. Others include multiple hooks or even multiple hook arrays. Moreover, most hooks include one or more barbs set back from the point to mitigate premature release.

While helpful in catching fish, these hook features create a more dangerous environment for the angler. Hooks can become more easily impaled in the skin of the angler and are more difficult to remove. Often, once the barb of the hook embeds within the skin, medical attention is required for removal.

Anglers continue to demand improved devices and methods to mitigate self-impalement without compromising fishing effectiveness or experience.

### BRIEF DESCRIPTION OF THE DRAWINGS

Embodiments are illustrated by way of example and are not intended to be limited in the accompanying figures.

FIG. 1 includes a perspective view of a device for fishing in accordance with an embodiment.

FIG. 2 includes a perspective view of a device for fishing in accordance with another embodiment.

FIGS. 3A to 3P illustrate embodiments of hook engagement portions in accordance with various embodiments described herein.

FIG. 4 includes a partial perspective view of a device for fishing in accordance with an embodiment.

FIG. 5 includes a perspective view of a device for fishing in accordance with an embodiment.

FIG. 6 includes a perspective view of a device for fishing in accordance with an embodiment.

FIG. 7 includes a cross-sectional view of a device for fishing in accordance with an embodiment.

FIG. 8 includes a view of a device for fishing engaged with the wrist of the angler in accordance with an embodiment.

FIG. 9 includes a rear view of a reel and rod engaged with a device for fishing in accordance with an embodiment.

FIGS. 10 to 15 include views of a device for fishing in accordance with an embodiment.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or device that comprises a list of features is not necessarily limited only to those features but may include other features not expressly listed or inherent to such method, article, or device. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The terms “generally,” “substantially,” “approximately,” and the like are intended to cover a range of deviations from the given value. In a particular embodiment, the terms “generally,” “substantially,” “approximately,” and the like refer to deviations in at least one direction of the value within 10% of the value, within 9% of the value, within 8% of the value, within 7% of the value, within 6% of the value, within 5% of the value, within 4% of the value, within 3% of the value, within 2% of the value, or within 1% of the value.

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the fishing and terminal tackle arts.

Anglers frequently change lures when fishing. One of the final steps in tying a new lure involves cinching a knot between the fishing line and lure. A device in accordance with one or more embodiments described herein may be used by the angler in cinching the knot. In an embodiment, the device may remove the angler's hand from a danger zone associated with an area where hook impalement is more readily possible. The device may engage with the angler's body, such as at the angler's wrist, during periods of non-use to facilitate quick access.

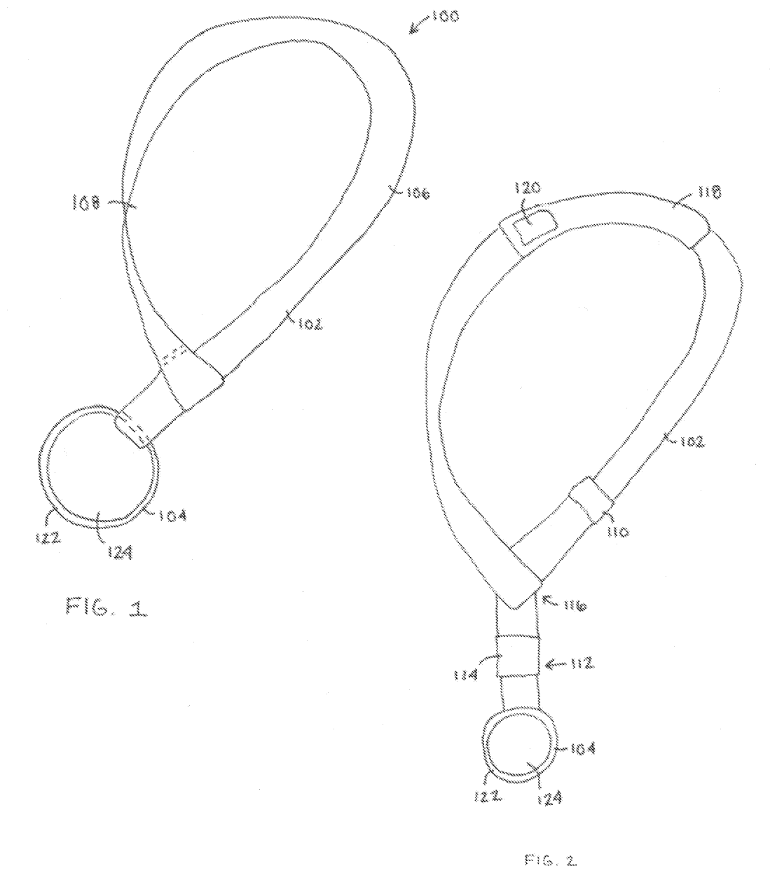

FIG. 1 illustrates an embodiment of a device 100 for fishing including a body engagement portion 102 adapted to be selectively secured to the body of an angler and a hook engagement portion 104 coupled with the body engagement portion 102. The hook engagement portion 104 can be configured to engage with a hook and permit the angler to manipulate the hook without impaling the hook into their hand.

In an embodiment, the body engagement portion 102 can include a band 106, such as a wrist band, adapted to extend around at least a portion of a wrist of the angler. As used herein, “wrist” can refer to any area of the arm extending between the shoulder and the fingertip. In a particular embodiment, “wrist” can refer to a portion of the arm, such as a joint or area proximate to the joint, connecting the hand with the forearm. In non-illustrated embodiments, the body engagement portion 102 can be coupled with a leg (e.g., foot, ankle, shin, thigh), torso, neck, waist, or other portion of the body. In certain instances, specific reference made herein to the angler's wrist may not exclude use with another part of the angler's body or a surface nearby. In certain instances, the body engagement portion 102 can be used to attach the device 100 to auxiliary equipment, such as a fishing rod, a boat accessory item, or another element within reach of the angler. In certain instances, reference to the body engagement portion 102 may include other attachment protocol and is not always limited to attachment with respect to the body of the angler.

In a non-illustrated embodiment, the device 100 can further include an auxiliary attachment (not illustrated) configured to be coupled with nearby equipment or surfaces. The auxiliary attachment can include, for example, one or more hooks, ties, tethers, clasps, buckles, magnets, carabiners, pins, fasteners, other coupling means, or any combination thereof adapted to couple with attachment protocol of an equipment, such as a rod, a reel, a fishing vest, a life vest, a belt, a hat, a neck tie, another article of clothing, a portion of a boat, a portion of another structure, or any combination thereof. In a particular embodiment, the angler may be able to selectively release a portion of the device 100, such as the hook engagement portion 104 from the body engagement portion 102, and utilize the auxiliary attachment to secure the portion of the device 100 to the angler's body. In certain instances, the body engagement portion 102 and auxiliary attachment may be used simultaneously. In other instances, the body engagement portion 102 and auxiliary attachment may be used separately.

In an embodiment, the body engagement portion 102 can define an opening 108 adapted to receive the wrist of the angler. In a particular embodiment, the opening 108 can define an adjustable circumference. In a more particular embodiment, the opening 108 can be infinitely adjustable. That is, the opening 108 can be adjustable to any dimension within an adjustment length of the band 106. In certain instances, the adjustable opening 108 can permit multi-person use of the device 100. That is, a single device 100 can accommodate anglers with various sized wrists (e.g., children and adults). In an embodiment, the opening 108 can define a generally ovular shape. In a more particular embodiment, the opening 108 can define a tear drop shape.

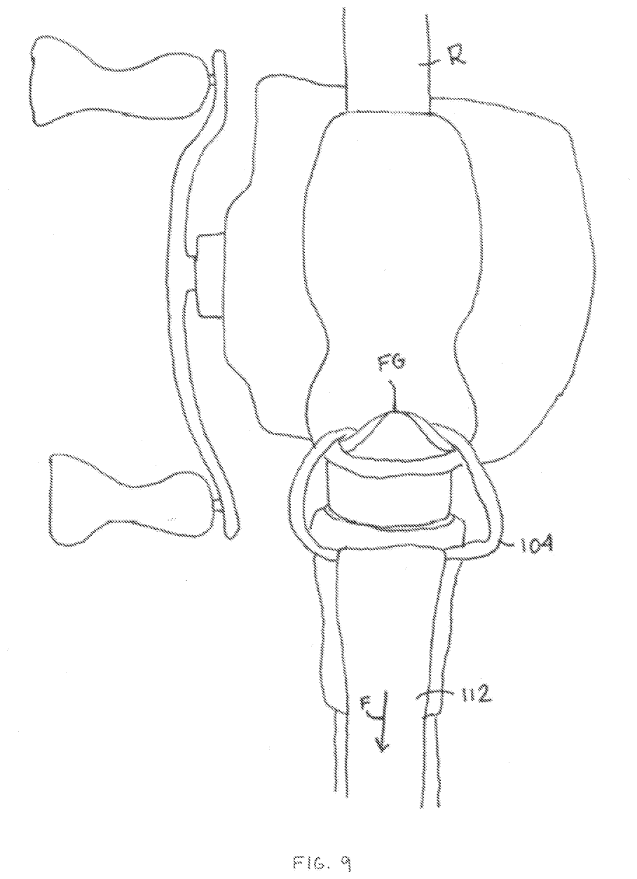

In an embodiment, the hook engagement portion 104 can be dynamically coupled with the body engagement portion 102. As used with respect to the hook engagement portion 104 and body engagement portion 102, “dynamically coupled” can refer to a condition whereby the body and hook engagement portions 102 and 104 are adjustable with respect to one another, such as for example, rotatable with respect to one another, pivotable with respect to one another, translatable with respect to one another, selectively detachable or attachable with respect to one another, otherwise deformable or moveable with respect to one another, or any combination thereof. FIG. 7 illustrates an exemplary embodiment of a dynamically coupled hook and body engagement portion.

In an embodiment, the hook engagement portion 104 can be non-detachably coupled with the body engagement portion 102. That is, for instance, the hook engagement portion 104 may be fixedly attached to the body engagement portion 102. In another embodiment, the hook engagement portion 104 can be detachably coupled with the body engagement portion 102. More particularly, the hook engagement portion 104 can be selectively detachable from the body engagement portion 102. In certain instances, the body and hook engagement portions 102 and 104 can be adapted to remain coupled together upon application of a separating force of at least 1 pound (lb) at least 5 pounds, at least 10 lbs, at least 15 lbs, at least 20 lbs, at least 25 lbs, at least 30 lbs, at least 40 lbs, at least 50 lbs, at least 60 lbs, at least 70 lbs, at least 80 lbs, at least 90 lbs, or at least 100 lbs. In a particular embodiment, the body and hook engagement portions 102 and 104 can be adapted to remain coupled together upon application of a separating force required to cinch a knot between a fishing line and hook.

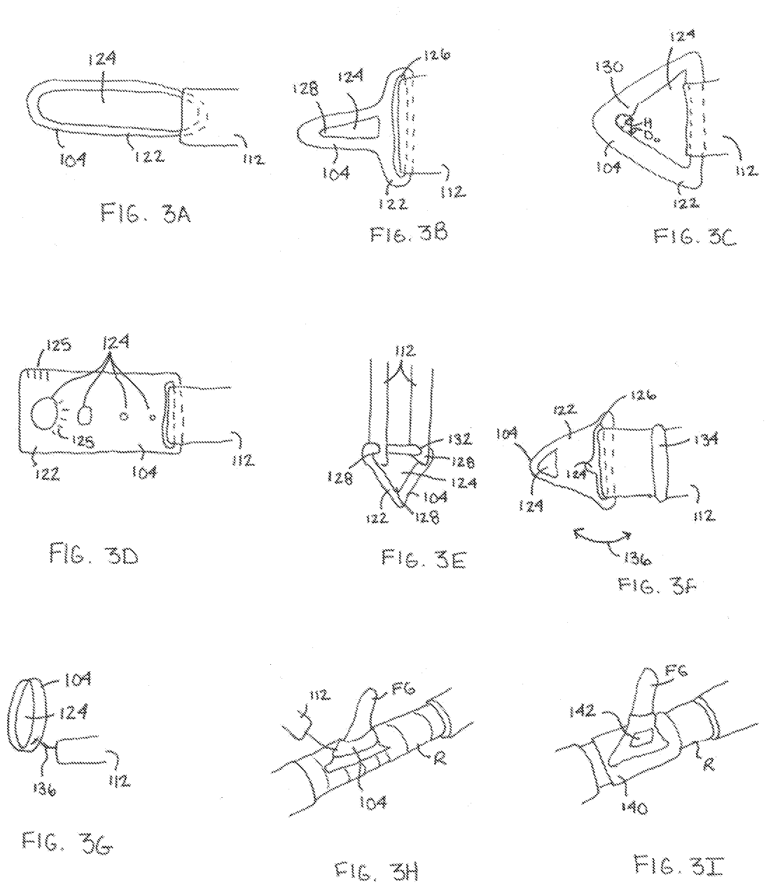

FIG. 2 illustrates an embodiment of the device 100 wherein the body engagement portion 102 includes an adjustable element 110 adapted to selectively adjust an affective size of the body engagement portion 102, e.g., the circumference of the opening 108. The adjustable element 110 can include, for example, one or more buckles, cams, sliders, ovals, ties, loops, clips, hook and loop engagement, another adjustable element, or any combination thereof.

In an embodiment, the hook engagement portion 104 can be separated from the body engagement portion 102 by an intermediate portion 112. The intermediate portion can include, for example, webbing, fabric, cordage or string, polymeric materials, or any combination thereof. In certain instances, the body engagement portion 102 and intermediate portion 112 can include a same composition, material, or structure. In other instances, the body engagement portion 102 and intermediate portion 112 can include different compositions, materials, or structures. For example, the body engagement portion 102 can include webbing and the intermediate portion 112 can include cordage.

In an embodiment, spatial relationship between the hook engagement portion 104 and the wrist of the angler can be independent of the configuration of the body engagement portion 102 relative to the wrist of the angler. That is, for example, the intermediate portion 112 may be adjustable in length, effective length, angular arrangement, or any combination thereof. In a particular embodiment, the effective length of the intermediate portion 112 can be infinitely adjustable over the length thereof. In another embodiment, the effective length of the intermediate portion 112 can be adjusted along a prefixed set of adjustment points.

In an embodiment, the hook engagement portion 104 or the intermediate portion 112 can be coupled or disposed adjacent to an apex 116 of the body engagement portion 102 (e.g., near the apex of the tear drop shape). The hook engagement portion 104 can be coupled at a relative angle with respect to the body engagement portion 102. FIG. 2, for example, illustrates the hook engagement portion 104 at a 0° orientation relative to the wrist engagement portion 102. In another embodiment, the hook engagement portion 104 can be oriented in a range between −90° and 90°, in a range between −60° and 60°, in a range between −45° and 45°, in a range between −20° and 20°, or in a range between −5° and 5°.

In an embodiment, the body engagement portion 102 can include a padded portion 118. The padded portion 118 can be disposed at a circumferential location of the body engagement portion 102 opposite, or generally opposite, the hook engagement portion 104. For example, the padded portion 118 can be disposed diametrically opposite the apex 116.

In an embodiment, the body engagement portion 102 can further include an interface 120 adapted to engage with another equipment. In certain instances, the interface 120 can be part of the previously described auxiliary attachment. In other instances, the interface 120 can be in addition to the auxiliary attachment or in lieu thereof. By way of example, the equipment can include a light, a blade, scissors, clippers, nippers, a fish grip, equipment storage, a camera remote, a camera, a fishing net, a mobile display device, a bait or tackle element, a paddle or oar, a rod or reel, a time keeping element, or any combination thereof. In a particular embodiment, the interface 120, or the equipment attached therewith, is selectively releasable from the device 100. That is, for example, the angler can detach the equipment from the interface 120.

In accordance with an embodiment, the hook engagement portion 104 can include a body 122 adapted to receive a hook. In an embodiment, the body 122 includes a resilient material adapted to withstand repeated stress incurred by knot cinching operations. The body 122 can be further adapted to avoid degradation in saltwater environments. Exemplary materials include metals, alloys, polymers, natural fibers, or any combination thereof. In certain instances, the body 122 may include one or more coatings or surface treatments.

In an embodiment, the body 122 can be essentially free of moving parts. “Essentially free of moving parts” can refer to a lack of moving parts corresponding with the process of hook engagement. That is, for example, the body 122 can include a moving part, such as a swivel, coupling the body 122 to the intermediate portion 112, but the body 122 can be devoid of moving parts specifically associated with the operation of applying cinching pressure to tighten a hook to fishing line. In a more particular embodiment, the body 122 can be entirely free of moving parts.

In an embodiment, the body 122 can include one or more moving parts adapted to assist the angler in coupling the body 122 with a hook. In a particular embodiment, the one or more moving parts can include a safety element adapted to prevent accidental detachment of the hook from the body 122 when in use. In another particular embodiment, the one or more moving parts can include components associated with a blade, scissors or clippers, a fish grip, a camera, a tackle storage, another equipment, or any combination thereof. In another particular embodiment, the body 122 can include one or more moving parts to assist the angler in engaging in another action, such as casting, reeling, or landing a fish.

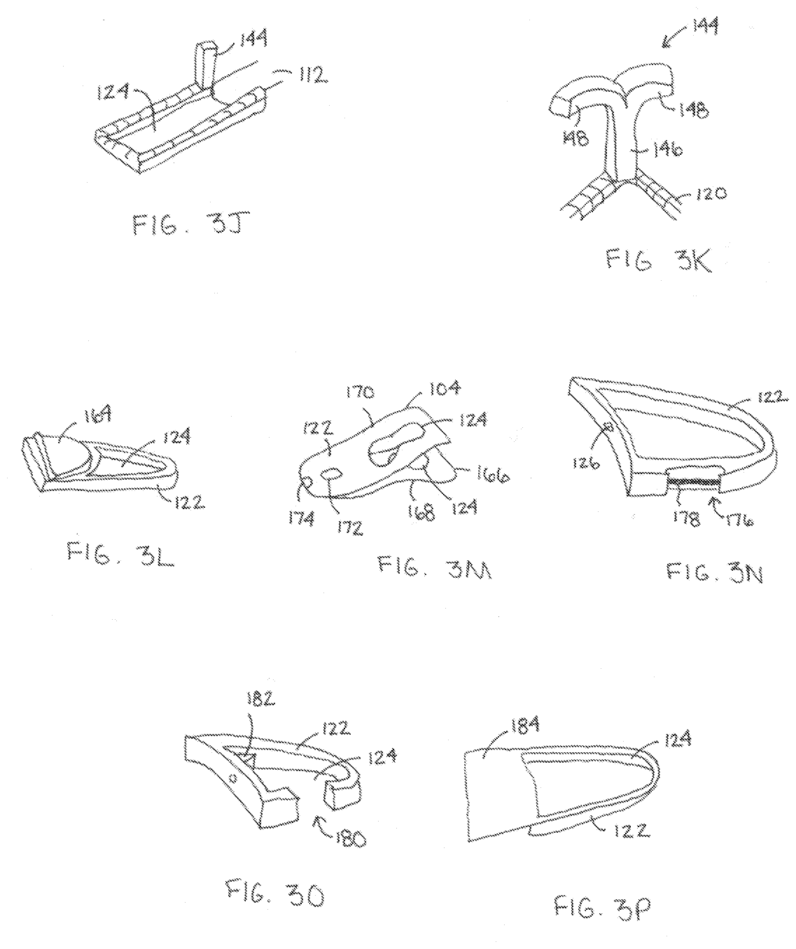

The hook engagement portion 104 can define a shape adapted to receive the hook. FIG. 3A illustrates a simplified view of the hook engagement portion 104 in accordance with an embodiment. In the illustrated embodiment, the hook engagement portion 104 has an arcuate shape. In another embodiment, the hook engagement portion 104 can have a polygonal shape, such as triangular. In yet another embodiment, the hook engagement portion 104 can have a shape including arcuate portions and linear portions. In an embodiment, the hook engagement portion 104 can be coupled with the body engagement portion 102 or intermediate portion 112. Reference made regarding FIGS. 3A to 3P with respect to engagement of the hook engagement portion 104 with either the body engagement portion 102 or intermediate portion 112 is non-exhaustive and may include the other or both.

In an embodiment, the hook engagement portion 104 can include an opening 124 with a shape similar to the shape of the body 122. In another embodiment, the opening 124 can have a shape different from the shape of the body 122. The hook can be received in the opening 124. In an embodiment, the opening 124 includes a lumen extending entirely through the body 122. In such instances, the hook can extend entirely through the body 122. In another embodiment, the opening 124 includes a concave portion extending into (but not entirely through) the body 122. In such instances, the tip of the hook can be disposed within the body 122. In another embodiment, the opening 124 can be selectively closed, e.g., by a cover.

FIG. 3B illustrates a simplified view of the hook engagement portion 104 in accordance with another embodiment. The body 122 and opening 124 of the hook engagement portion 104 are shaped differently from each other. In an embodiment, the body 122 can further include an auxiliary opening 126 adapted to engage with the intermediate portion 112. In an embodiment, the auxiliary opening 126 can include arcuate portions, linear portions, or a combination thereof.

In an embodiment, hook engagement portion 104 can be adapted to guide the hook to a correct location with respect to the hook engagement portion 104 prior to or during tightening of the hook to the fishing line. In a particular embodiment, the opening 124 can define a tapered portion 128. The tapered portion 128 can be sized or shaped to guide the hook to a specific operable zone of the body 122.

FIG. 3C illustrates a simplified view of the hook engagement portion 104 in accordance with yet a further embodiment. As illustrated, the hook engagement portion 104 includes a retention feature 130 adapted to mitigate undesired disengagement of the hook H from the body 122 of the hook engagement portion 104. As illustrated, the retention feature 130 can be disposed adjacent to an apex of the tapered portion 128. The retention feature 130 can include, for example, a notch, a groove, a tine, a rotatable feature, a magnet, a biasing element, a clip, a strap, a textured portion of the body 122, another retaining element, or any combination thereof. In a particular embodiment, the opening 124 can have a restricted dimension, Do, as measured at the retention feature 130, less than a diameter of the hook, such as less than 0.999 Do, or less than 0.95 Do, or less than 0.9 Do. After the hook passes the restricted dimension, Do, it can be at least partially secured with the hook engagement portion 104 such that the possibility of accidental disconnection therebetween is reduced. In certain instances, the angler may receive a signal, such as a tactile or audible signal, confirming the hook is engaged with the body 122 by the retention feature 130.

FIG. 3D illustrates a simplified view of the hook engagement portion 104 in accordance with a further embodiment. As illustrated, the hook engagement portion 104 includes a body 122 defining a plurality of openings 124. In the illustrated embodiment, the plurality of openings 124 all define different diameters. In another embodiment, at least two of the openings 124 can have a same diameter as one another. At least one of the openings 124 can define an ovular shape such as a circle; a polygon such as a triangle, quadrilateral, pentagon, etc.; or a shape having curvilinear portions and linear portions. In some embodiments, the openings 124 can all have different shapes. In other embodiments, the openings 124 can all have the same shape. In the illustrated embodiment, the openings 124 are disposed along a straight line. In another embodiment, the openings 124 can be arranged along multiple columns, multiple rows, or a combination thereof. In an embodiment, at least one of the openings 124 can extend entirely through the thickness of the body 122. In another embodiment, at least one of the openings 124 includes a concave recess that does not extend through the entire thickness of the body 122. In certain instances, the body 122 can define a measuring device, such as indicia 125, for measuring a relative dimensional size of the hooks being used.

FIG. 3E illustrates a simplified view of the hook engagement portion 104 in accordance with yet another embodiment. The hook engagement portion 104 is coupled with the intermediate component 112 at more than one location, such as at two locations 132. In certain instances, the body 122 of the hook engagement portion 104 can be rotatable or translatable with respect to the intermediate component 112. In a particular embodiment, the hook engagement portion 104 can define a different utility or function at each different position, such as at different rotational or translational positions, with respect to at least one location of the intermediate component 112. For example, the illustrated body 122 can include three tapered sections 128 each terminating at an apex. In an embodiment, the apexes of at least two of the tapered sections 128 can be different as compared to one another. For example, one of the tapered sections 128 can receive a first hook and another of the tapered sections 128 can receive a second hook different than the first hook, for example, in diameter.

FIG. 3F illustrates a simplified view of the hook engagement portion 104 in accordance with another embodiment. The illustrated hook engagement portion 104 is in the non-stored (e.g., usable) configuration. The device 100 can include an engagement element 134 adapted to support the hook engagement portion 104 when in a stored (e.g., not readily usable) configuration. The engagement element 134 can be coupled with the hook engagement portion 104, the wrist engagement portion 102, the intermediate portion 112, or another portion of the device 100. The engagement element 134 can include, for example, a band, a tether, a hook, a loop, a fastener, a buckle, a button, a latch, a magnet, another engagement element, another coupling element, or any combination thereof.

In certain instances, the angler may wish to relocate the hook engagement portion 104 to a non-use configuration whereby the hook engagement portion 104 can be stored. In an embodiment, the hook engagement portion 104 can be rotated in a direction corresponding with arrow 136 between stored and non-stored configurations. In certain instances, the hook engagement portion 104, or a portion thereof, can remain visible in the stored position. In other instances, the hook engagement portion 104, or a portion thereof, can be hidden from site when stored.

In the illustrated embodiment, at least one of the openings 124 of the hook engagement portion 104 can be common with the auxiliary opening 126 adapted to receive the intermediate portion 112. Referring again to FIG. 3B, in other embodiments, the opening 124 and auxiliary opening 126 can be discrete openings in the body 122.

FIG. 3G illustrates a simplified view of the hook engagement portion 104 in accordance with another embodiment. The illustrated hook engagement portion 104 is coupled to the intermediate portion 112 through an element 136 coupled with the body 122 of the hook engagement portion 104. In an embodiment, the element 136 can include cordage having a shape or size different than the intermediate portion 112. In another embodiment, the element 136 can include a cord, string, wire, fabric, or another readily flexible material. In other embodiments, the element 138 can be rigid or relatively inflexible.

In an embodiment, the body 122 of the hook engagement portion 104, or portion thereof, can be shaped to fit around a finger of the angler. In certain instances, the angler can insert a finger into the body 122, or portion thereof, when fishing, such as during periods where the angler is not tying hooks to the fishing line, when the angler is casting, when the angler is reeling, when the angler is grabbing a fish, another angling time, or any combination thereof. Positioning the body 122 of the hook engagement portion 104 on a finger of the angler can store the hook engagement portion 104 so that it does not dangle. In an embodiment, the angler may insert, or maintain, their finger in the body 122, or portion thereof, when tying or cinching knots to better grip the body 122, hook, or both.

In certain instances, use of the device 100 after placement of the body 122 on the finger of the angler can increase casting strength, can increase casting distance, can reduce internal physical stress on the joints, or any combination thereof. In an embodiment, the angler can adjust the size of the device 100, such as at the intermediate portion 112, wrist engagement portion 102, or hook engagement portion 104. When properly fitting, tension can form along the device 100 between the finger of the hand and the wrist engagement portion 102 when the wrist is in extension during performance of a casting motion. The resulting tension can protect the wrist joint from repetitive stress during use. Moreover, the resulting tension can affect positive increase in force delivered to the rod during casting with a same input force from the angler. In an embodiment, the hook engagement portion can be referred to as a fishing equipment engagement portion.

FIG. 3H illustrates a simplified view of the hook engagement portion 104 in accordance with another embodiment as coupled with a finger grip FG of a rod R. Such finger grips FG are common on baitcasting rods and are typically disposed opposite, or generally opposite, a reel. In an embodiment, the illustrated hook engagement portion 104, or another portion (not illustrated) of the device 100 can be adapted to extend around at least a portion of the finger grip GP. The hook engagement portion 104 or another portion can be adapted to selectively couple with the finger grip FG or other portion of the rod R. In certain instances, the hook engagement portion 104 or other portion can provide similar benefits to the hook engagement portion 104 illustrated and described with respect to FIG. 3G. More specifically, the hook engagement portion 104 can assist in casting, reeling, or other aspects of fishing.

FIG. 3I illustrates a simplified view of the hook engagement portion 104 in accordance with another embodiment as coupled with the finger grip FG. In the illustrated embodiment, the hook engagement portion 104, or another portion (not illustrated) is adapted to selectively couple with a component 140 coupled with, such as detachably coupled with, the rod R, such as at the finger grip FG. In an embodiment, the component 140 can include a cover for the rod R, such as a cover for the finger grip FG. The device 100 can detachably engage with the component 140 to engage with wrist of the angler with the rod R to assist in casting, reeling, or other aspects of fishing. The component 140 can include a detachable coupling point 142 (or points) where the device 100 can selectively couple with the component 140.

In certain instances, at least a portion of the intermediate portion 112 is adapted to contact a palm of the hand of the angler when the hook engagement portion 104 is coupled with the finger of the angler or the rod R, or when the hook engagement portion 104 is being used to cinch a knot, cut line, or perform another function. In a particular embodiment, the intermediate portion 112 can include a contact area (not illustrated) adapted to contact the palm of the hand of the angler. The contact area can include, for example, a softened portion, a reinforced portion, an easier to grab portion, or any combination thereof. In certain instances, at least a portion of the hook engagement portion 104 or intermediate portion 112 is adapted to be disposed between the rod and the wrist of the angler when the body 122 of the hook engagement portion 104 is coupled with finger of the angler or the rod R.

In an embodiment, the device 100 can remain attached to the body, such as the wrist, of the angler when not actively in use. That is, for example, the angler can cinch a hook with the device 100 and then engage in casting while the device 100 remains affixed to the wrist of the angler. By way of another example, the angler can use the device 100 coupled with the rod and then engage in a non-fishing activity while the device 100 remains affixed to the wrist of the angler. In such a manner, the device is not readily lost or misplaced and is always ready for immediate use.

FIG. 3J illustrates a simplified view of the hook engagement portion 104 in accordance with another embodiment. The hook engagement portion 104 includes a stay 144. In a particular embodiment, the stay 144 can extend from the body 122 and be adapted to engage with a hand of the angler. In a more particular embodiment, the stay 144 can be adapted to extend between fingers, such as adjacent fingers, of the angler's hand. In such a manner, the angler can maintain the hook engagement portion 104 at a fixed position relative to the angler's hand when the hook engagement portion 104 is not actively in use. Further, in a particular embodiment the stay 144 can permit enhanced casting distance as previously described when engaged with the rod R, finger of the angler, or a combination thereof.

FIG. 3K illustrates a simplified view of an exemplary stay 144 in accordance with a particular embodiment. The stay 144 can include, for instance, a shape having a base 146 extending from the body 122 with at least one grippable element 148 coupled with the base 146. In an embodiment, the base 146 can be configured to extend between fingers, such as adjacent fingers, of the hand of the angler. The grippable element 148 can prevent removal of the body 122 from the angler's grasp. In certain instances, the grippable element 148 can be angled, curved, or otherwise have a curvilinear profile.

FIG. 3L illustrates a simplified view of the hook engagement portion 104 in accordance with another embodiment, wherein the body 122 of the hook engagement portion 104 can include a pad 164. In an embodiment, the pad 164 can be disposed adjacent to the opening 124. The pad 164 can define a user grippable area of the hook engagement portion 104. In certain instances, the pad 164 can be raised relative to other parts of the body 122. In other instances, the pad 164 can include a textured or coated surface to enhance grippability. In yet other instances, the pad 164 can include indicia. The indicia can include, for example, information about the device 100 or a portion thereof, a process for using the device 100, or both. In certain instances, the pad 164 may be larger than the opening 124. In an embodiment, the pad 164 can include a concave portion. In another embodiment, the pad 164 can include ridges, projections, or other greppable portions. In certain instances, the pad 164 may be switchable between one or more configurations or positions. By way of example, the different configurations can correlate with different device 100 configurations or uses.

FIG. 3M illustrates a simplified view of the hook engagement portion 104 in accordance with another embodiment. The hook engagement portion 104 can include a body 122 defining an auxiliary portion 166 adapted to provide an auxiliary function to the hook engagement portion 104. By way of non-limiting example, the auxiliary portion 166 can include cutters, such as two sharpened surfaces dynamically coupled together, to permit an angler to cut fishing line. In the illustrated embodiment, the auxiliary portion 166 is formed by a first member 168 and a second member 170 coupled together at a pivot point 172. The first and second members 168 and 170 can pivot open and closed to permit auxiliary 166 functionality. For instance, the angler can squeeze the first and second members 168 and 170 together (or permit the first and second members 168 and 170 to move apart) to engage the auxiliary 166 functionality.

In an embodiment, at least one of the first and second members 168 and 170 can include an opening 124 adapted to receive a hook. In the illustrated example, the first and second members 168 and 170 both include openings 124. In such a manner, the angler can select the opening 124 of either the first or second member 168 or 170 or use both openings 124 together. The hook engagement portion 104 can be coupled to the intermediate portion 112, for example, by a coupling point 174. In an embodiment, the coupling point 174 can be disposed opposite the auxiliary portion 166. In a more particular embodiment, the opening 124 can be disposed between the coupling point 174 and the auxiliary portion 166. In another embodiment, the coupling point 174 can be disposed adjacent to the auxiliary portion 166.

FIG. 3N illustrates a simplified view of the hook engagement portion 104 in accordance with another embodiment. The hook engagement portion 104 can include a body 122 defining a sharpened portion 176 adapted to permit an angler to selectively cut fishing line. In an embodiment, the sharpened portion 176 can include a blade 178 at least partially embedded within the body 122. In another embodiment, the sharpened portion 176 can include a blade coupled to an exterior surface of the body 122. The auxiliary opening 126 can permit engagement of the hook engagement portion 104 with the intermediate portion 112.

FIG. 3O illustrates a simplified view of the hook engagement portion 104 in accordance with another embodiment. The hook engagement portion 104 can include a body 122 defining a transverse hook passage 180. The hook passage 180 can permit transverse insertion of a hook into the opening 124. The transverse hook passage 180 can include, for instance, a discontinuous portion of the body 122. In an embodiment, the transverse hook passage 180 can be in fluid communication with the opening 124. In certain configurations, one or more reinforcing portions 182 can be included to structurally reinforce the body 122. The reinforcing portion(s) 182 can be arranged to decrease deformation of the body 122 during use. In an embodiment, the reinforcing portion(s) 180 can be integral to the body 122. In another embodiment, the reinforcing portion(s) 182 can include one or more discrete components coupled to the body 122.

FIG. 3P illustrates a simplified view of the hook engagement portion 104 in accordance with another embodiment. The hook engagement portion 104 can include a tail 184 extending from the body 122. In certain instances, the tail 184 can enhance usage, storage, or aesthetic of the hook engagement portion 104. In a particular embodiment, the tail 184 can be adapted to be grasped by an angler during usage.

In an embodiment, the tail 184 can be integrally formed with the body 122. In another embodiment, the tail 184 can include a discrete component coupled to the body 122. In an embodiment, the tail can define an adjustable portion (not illustrated) adapted to permit adjustment of the size or shape of the tail 184. For example, the tail 184 can be adapted to collapse in a direction toward the opening 124 as the hook engagement portion 104 approaches the body engagement portion 102. By way of non-limiting example, the tail 184 may be biased by the body engagement portion 102 or a housing (FIG. 7). In another embodiment, the tail 184 can be adapted to engage, seat relative to, or otherwise interact with the housing at one or multiple instances.

Embodiments illustrated in FIGS. 3A to 3P are not meant to be exclusive and can be combined, interchanged, and otherwise modified as described herein and as understood by one of ordinary skill in the art.

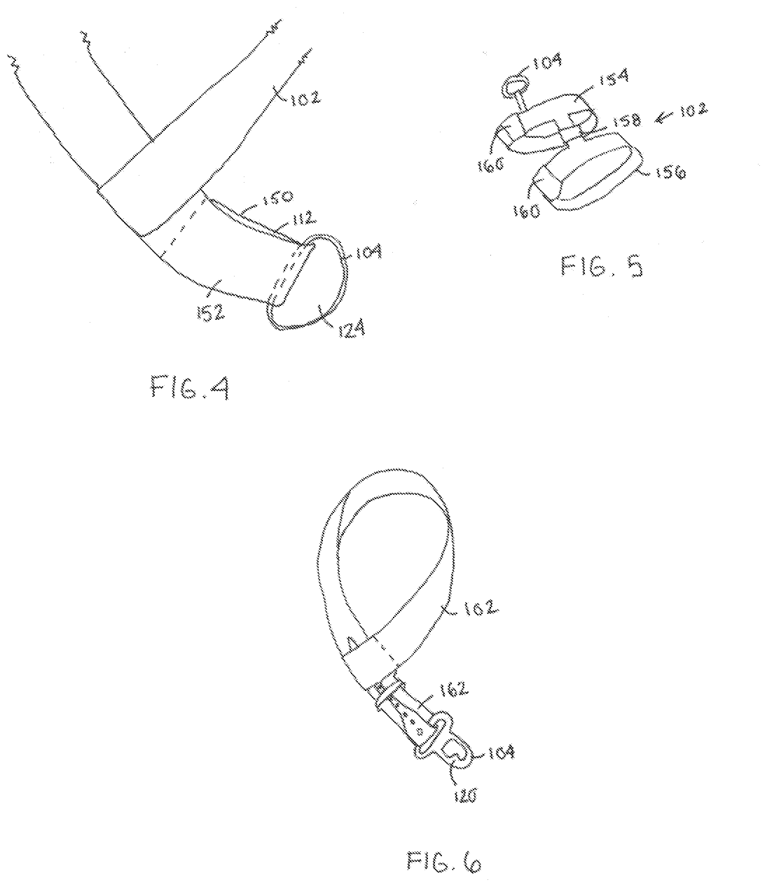

FIG. 4 illustrates an intermediate portion 112 in accordance with an embodiment. In the illustrated embodiment, the intermediate portion 112 includes an elastic portion 150 and an inelastic portion 152. In an embodiment, the elastic portion 150 can have a maximum length, as measured when fully stretched, that is less than or equal to the length of the inelastic portion 152. In another embodiment, the elastic portion 150 can have a maximum length, as measured when fully stretched, that is greater than the length of the inelastic portion 152.

In certain instances, use of an elastic portion 150 and inelastic portion 152 can permit the angler to selectively extend the hook engagement portion 104 when in use. Moreover, the hook engagement portion 104 can be biased to a retracted position by the elastic portion 150 so as to be out of the way of the angler when not in use. In certain instances, the use of inelastic portion 152 can provide a fixed maximum length of the intermediate portion 112. For example, the elastic portion 150 may degrade over time, such as after repeated exposure to harsh environmental conditions (e.g., saltwater). The inelastic portion 152 can remain effective even after wear and fatigue of the elastic portion 150. In certain embodiments, the elastic portion 150 can be replaceable. More specifically, the angler can replace the elastic portion 150 after retracting capacity of the elastic portion 150 is diminished beyond an acceptable amount.

In the embodiment illustrated in FIG. 4, the wrist engagement portion 102 and the intermediate portion 112 are integral (e.g., monolithic) with one another.

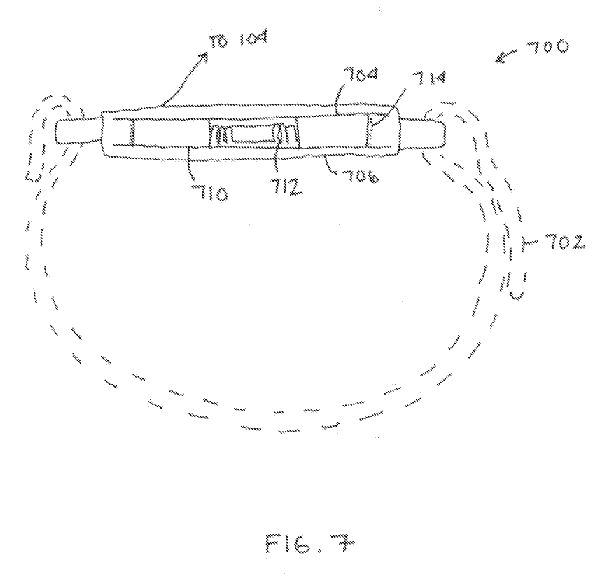

FIG. 5 illustrates an embodiment of the device 100 including a body engagement portion 102 with at least two engagements 154 and 156. In an embodiment, the engagements 154 and 156 can both extend around the wrist of the angler. In certain instances, at least one of the engagements 154 or 156 can include an adjustable element 160 adapted to permit selective resizing of the engagement 154 or 156. In an embodiment, a connective element 158 extending between adjacent engagements 154 and 156 can have an adjustable element 160 adapted to accommodate anglers of various sizes (e.g., adults and children).

The hook engagement portion 104 can be coupled with the body engagement portion 102 at either or both of the wrist engagements 154 and 156 and can optionally engage with the connective element 158.

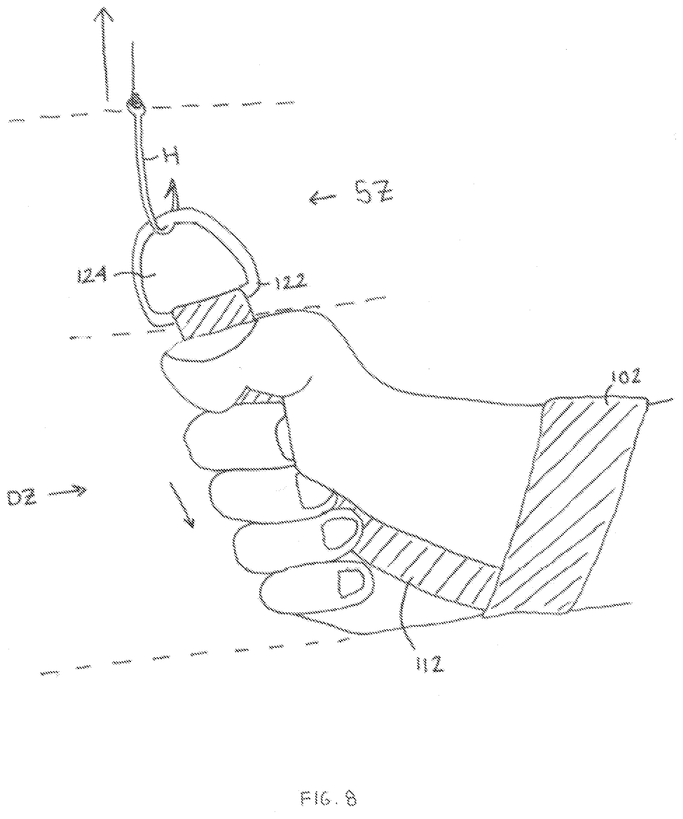

FIG. 6 illustrates a device 100 including a body engagement portion 102 with an adjustable length defined by an adjustable interface 162. In an embodiment, the adjustable interface 162 can extend through a portion of the hook engagement portion 104, such as the body 122, and have discrete or infinite adjustment capability. In the illustrated embodiment, the adjustable interface 162 includes a plurality of discretely located adjustment positions. In another embodiment, the adjustable interface 162 can be infinitely adjustable, as previously described. In an embodiment, the adjustable interface 162 can be releasable, such that the hook engagement portion 104 can be selectively detached from the body engagement portion 102. In certain instances, the hook engagement portion 104 may be released from the body engagement portion 102 to swap hook engagement portions 104, to swamp body engagement portions 102, to clean or service the hook engagement portion 104 or body engagement portion 102, or for another non-fishing related activity. In another instance, the hook engagement portion 104 may be released from the body engagement portion 102 during fishing related activities. For example, in a particular embodiment, the hook engagement portion 102 may be selectively releasable from the body engagement portion 102 when engaging with a hook. The angler can selectively uncouple the hook engagement portion 102 prior to, during, or after engaging the hook engagement portion 102 with the hook.

FIG. 7 includes a cross-sectional side view of a device 700 in accordance with an embodiment described herein. In certain instances, the device 700 may include any one or more of the features previously described with respect to device 100. For instance, the device 700 may include a body engagement portion 702 having one or more similar features as described with respect to the body engagement portion 102, and an intermediate portion 704 having one or more similar features as described with respect to the intermediate portion 112. The intermediate portion 704 may be adapted to be coupled with a hook engagement portion 104 (not illustrated). In an embodiment, the body engagement portion 702 can define a wrist engagement including, for example, an adjustable wrist band.

In an embodiment, the intermediate portion 704 can include a housing 706 defining an interior volume 708. The housing 706 may be coupled with the body engagement portion 702. In an embodiment, the intermediate portion 704 can further include a retention member 710 disposed at least partially within the housing 706. The retention member 710 can be adapted to selectively release a connecting part 714 of the intermediate portion 704, such as a line or cord, a rigid member, a flexible member, or any combination thereof, connecting the retention member 710 to the hook engagement portion 104.

In an embodiment, the retention member 710 can be biased by one or more springs 712, such as for instance, coiled springs, cantilevered springs, deformable elastic members, other suitable biasing members, or any combination thereof. The one or more springs can, for example, rotatably bias the retention member 710 to a first configuration (e.g., a stored position). Application of an action on the device 700 (e.g., angler's use thereof in tying a knot) can cause the retention member 710 to move to a second configuration (e.g., an in-use position). In an embodiment, the force applied on the connecting part 714 can affect the effective length thereof. For example, the hook engagement portion 104 may be moved relative to the housing 706, causing deployment of the connecting part 714 from the housing 706.

In an embodiment, the connecting part 714 can define a maximum effective length greater than a distance between the housing 706 and the hook engagement portion 104, as measured in use in a cinching operation. That is, the hook engagement portion 104 may be used at an effective length of the connecting part 714 than the maximum length thereof. In such a manner, the hook engagement portion 104 or another portion of the device 700 may be used at a further extended length for other fishing or non-fishing activities. The device 700 may also be used at a retracted length for other fishing or non-fishing activities.

In an embodiment, the retention member 710 can define a hub adapted to rotate about a center axis. As the hub rotates, the connecting part 714 can be released and retracted into the housing 706.

In an embodiment, rotation of the hub may be selectively controllable by the angler. For example, in a first instance, the hub may be adapted to rotate in a first direction while restricted from rotating in a second direction. “Restricted from rotating” can refer to a condition of substantially no rotation upon application of a reasonable force. In a second instance, the hub may be adapted to freely rotate in both the first and second directions. In a third instance, the hub may be adapted to freely rotate in the second direction while restricted from rotating in the first direction. In an embodiment, the angler can select between the first, second, and third instances by adjusting the device 700 or a component thereof. In a particular embodiment, the device 700 may include a user-select feature (not illustrated), such as a dial, a button, a lever, a switch, or any combination thereof adapted to permit user selection. In another embodiment, the device 700 may be capable of only one of the first, second, or third instances.

In an embodiment, the hub may be adapted to freely rotate in a direction to release the connecting part 714 and be restricted from rotating in a direction to wind the connecting part 714 when the user-select feature is in a first configuration. The hub may be adapted to freely rotate at least in the direction to wind the connecting part 714 when the user-select feature is in a second configuration. The first configuration may include, for example, a button in an unbiased position, and the second configuration may include, for example, the button in a biased (e.g., plunged) position.

In a non-illustrated embodiment, the intermediate portion can define a plurality of connecting parts 714. The plurality of connecting parts 714 can be coupled to a same equipment (e.g., to the hook engagement portion 104) or to different equipment (e.g., one connecting part 714 can be coupled to the hook engagement portion 104 and the other connecting part 714 can be connected to clippers, fishing tools, non-fishing tools, etc.).

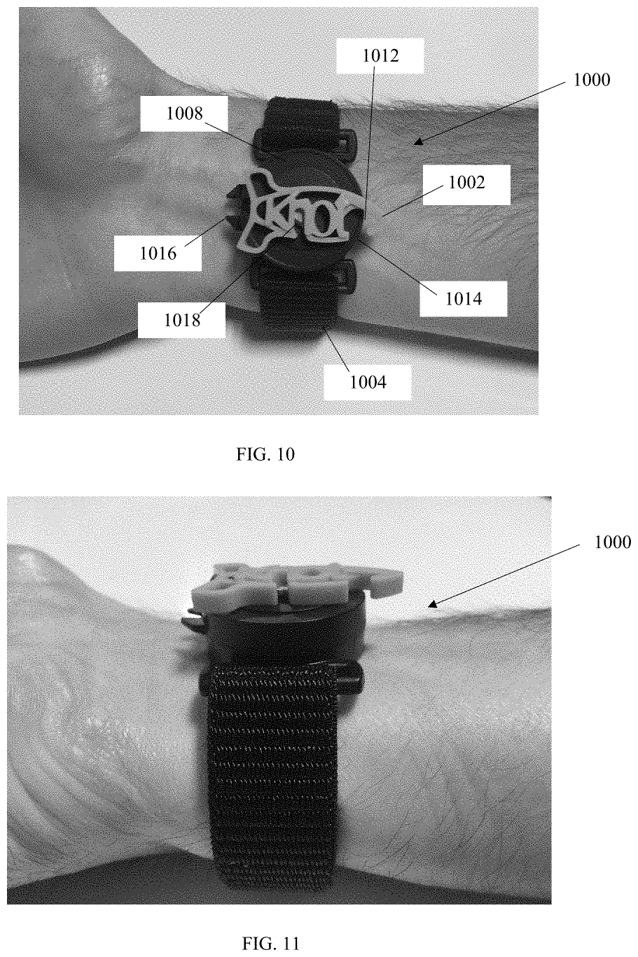

Referring to FIG. 8, a method of using a fishing device in accordance with an embodiment described herein can generally include attaching the device 100 to the angler. In an embodiment, attachment of the device 100 can include inserting one's hand into the opening 108 of the body engagement portion 102 and adjusting the size of the opening 108 until the body engagement portion 102 is comfortably secure on the angler, such as on the angler's wrist. In an embodiment, the body engagement portion 102 can be disposed adjacent to the wrist joint of the angler when worn. In another embodiment, the body engagement portion 102 can be disposed between the shoulder and fingertip of the angler.

Once attached, the angler may utilize the device 100 to apply cinching pressure to a knot attaching a hook to a fishing line. It is noted that cinching can be performed with the device 100 without threat of impaling the hand of the angler into the hook. More specifically, the device 100 can mitigate dangers associated with the hand slipping relative to the hook during cinching.

When cinching a knot, there are generally two zones—a danger zone DZ and a safe zone SZ. The safe zone SZ may correspond with an area relative to the angler whereby slippage of the angler's body (e.g., the angler's hand) relative to the hook poses reduced risk of hook impalement. The danger zone DZ may correspond with an area where slippage of the angler's body poses risk of hook impalement more typical of risk associated with cinching a knot without use of the device 100.

In an embodiment, when using the device 100 the hook (or a sharpened portion thereof) can be at least partially disposed in the safe zone SZ during cinching operations. In a more particular embodiment, the hook (or a sharpened portion thereof) can be entirely disposed in the safe zone SZ during cinching operations. To the contrary, tightening the knot without use of the device 100 results in the hook being disposed in a danger zone DZ whereby slippage of the hand relative to the hook can result in impalement during knot tightening operations.

In use, the hook engagement portion 104 can be moved to an operating area of the angler's hand, e.g., gripped by fingers of the angler's hand. By way of non-limiting example, the operating area of the angler's hand can be disposed between a thumb and index finger of the hand. This area may correspond with the safe zone SZ of the angler's body.

In an embodiment, the hook engagement portion 104 can be moved to the operating zone by the hook or fishing line. For instance, the hook engagement portion 104 may be disposed adjacent to the housing 706 of the intermediate portion 704 (FIG. 7) prior to engagement with the hook. After coupling the hook to the hook engagement portion 104, the angler can pull the hook to relocate the hook engagement portion 104 to the operating zone. In another embodiment, the angler may relocate, or partially relocate, the hook engagement portion 104 to the operating zone prior to engagement with the hook. The hook can then be coupled with the hook engagement portion 104 within the operational zone.

Once the hook is coupled to the hook engagement portion 104 within the operational zone, the angler can cinch the knot tying the hook and fishing line together. Specifically, the angler can exert biasing pressure on the device 100, the rod R or fishing line, or a combination thereof until the knot is secured. In an embodiment, the angler can cinch the knot to a final fishing-ready tightness without touching the hook H or any lure or component associated therewith (not illustrated).

In an embodiment, cinching a knot with the device can be performed without the angler contacting the hook at any point. In certain instances, the angler can pull on the hook utilizing the body engagement portion 102 alone, without further gripping the intermediate portion 112 or hook engagement portion 104. In an embodiment, the angler can tighten the hook to the fishing line by twisting the wrist—such as pronating the wrist or supinating the wrist, extending the wrist or inflecting the wrist. That is, in an embodiment, tightening the knot between the hook and fishing line can be performed with a rotational force, a linear force, or a combination thereof.

After securing the hook to the fishing line using the device 100, the angler can detach the hook from the hook engagement portion 104. In an embodiment, detachment can include releasing tension in the device 100. In another embodiment, detachment can include removing the hook from the retention element 130. In a further embodiment, detachment can include grasping and biasing the hook from the opening 124. In yet another embodiment, detachment can include releasing an interface or mechanism to permit removal of the hook from the hook engagement portion 104. In another embodiment, detachment can include rotating or translating the angler's wrist. In a further embodiment, detachment can include transversely sliding the hook from the opening 124 through a transverse hook passageway. In yet a further embodiment, detachment can include any combination of detensioning the device 100, removing the hook, grasping and biasing the hook, releasing an interface or mechanism, transversely sliding, and rotating the wrist or arm.

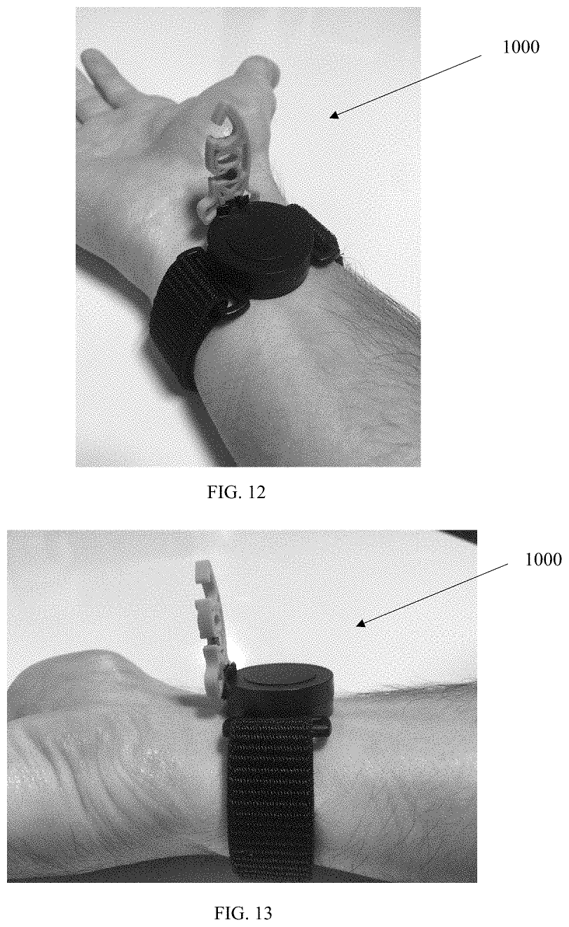

Referring to FIG. 9, in certain instances, the angler can engage the hook engagement portion 104 (or a rod engagement portion part of, the same, or discrete from the hook engagement portion 104) with the rod R, such as at the finger grip FG, in a manner as previously described. In such a manner, the angler can enhance casting performance, including but not limited to increased casting distance, increased casting accuracy, increased casting ease, decreased joint stress, or a combination thereof. In certain instances, assistance from the device 100 in casting performance can occur by providing a force to the rod R, such as along line F.

In an embodiment, the angler can selectively switch between using the device 100 to cinch a knot and cast.

In an embodiment, the angler can wear the device 100 even when not in use. In such a manner, the angler can have quick access to the device 100 for rapid lure switching or casting.

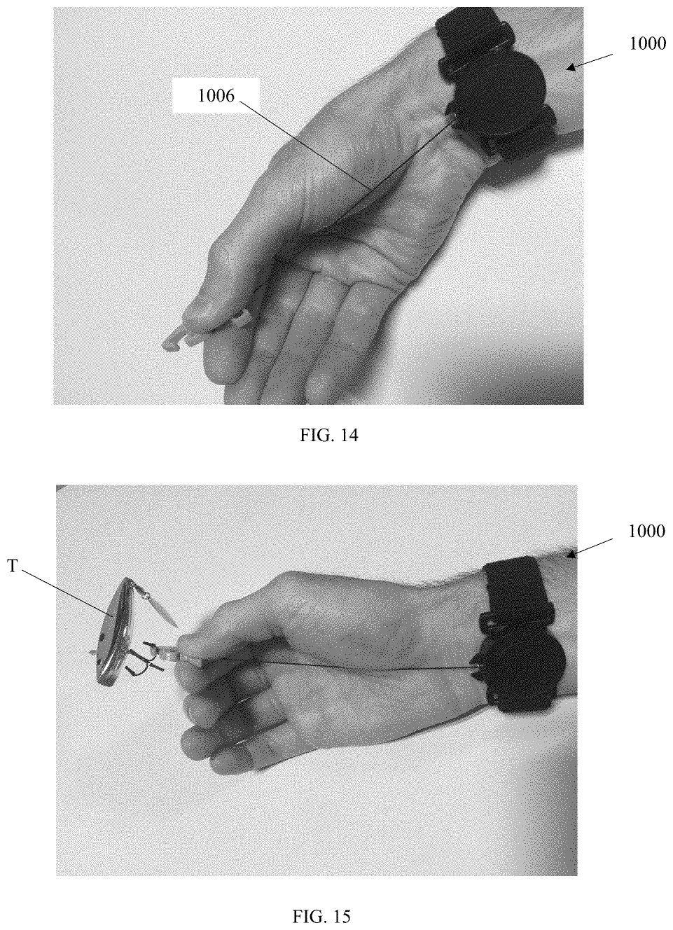

FIGS. 10 to 15 illustrate an embodiment of a fishing device 1000 including a hook engagement portion 1002 and a body engagement portion 1004. The hook engagement portion 1002 is coupled to the body engagement portion 1004 through an intermediate portion 1006 (FIG. 14). In an embodiment, the intermediate portion 1006 can include cordage. The intermediate portion 1006 can retract into a body 1008 of the body engagement portion 1004, permitting the hook engagement portion 1002 to retract toward the body 1008. A magnet or magnetically attractive element 1010 on the body engagement portion 1004 can be configured to couple with a magnet or magnetically attractive element (not illustrated) on the hook engagement portion 1002.

A hook receiving area 1012 of the hook engagement portion 1002 configured to receive a hook during knot cinching operations may include a transverse cutout 1014 to permit entry of a fishing hook laterally into the hook receiving area 1012. Use of the transverse cutout 1014 may permit the angler to quickly release the hook from the device 1000 by rotating the hook engagement portion 1002.

FIGS. 10 and 11 illustrate the device 1000 in a stored position on an angler's wrist. In this position, the hook engagement portion 1002 is stored on a surface of the body 1008 of the body engagement portion 1004. Prior to engaging the hook engagement portion 1002 with a terminal tackle, the hook engagement portion 1002 can be repositioned to a terminal tackle engagement position, illustrated in FIGS. 12 and 13. In an embodiment, the terminal tackle engagement position can be facilitated by one or more projections extending from the side of the body 1008. See, for example, the projections 1016 in FIG. 10. In another embodiment, the hook engagement portion 1002 can be maintained in the terminal tackle engagement position by another means, such as, for example, magnets, a surface, a fastener, or any combination thereof. In the terminal tackle engagement position, terminal tackle may be selectively coupled to the hook engagement portion 1002. The hook engagement portion 1002 may then be moved to a cinching position illustrated in FIGS. 14 and 15. After cinching is completed, a cutting surface 1018 may be used to cut excess fishing line.

The hook engagement portion 1002 may be moveable with respect to the body 1008 as illustrated in FIG. 14. In the in-use configuration, illustrated in FIGS. 14 and 15, the hook engagement portion 1002 may engage with the terminal tackle T, allowing the angler to apply cinching force to the terminal tackle through the hook engagement portion 1002. After application of the cinching force, the hook engagement portion 1002 may be returned to the stored position.

In certain instances, the device can be used to mitigate hook impalement which can occur, for example, when tightening a hook relative to a fishing line, holding the hook, or during another fishing activity. More particularly, after loosely tying a fisherman's knot, a palomar knot, or another knot to secure a terminal tackle to a fishing line, the angler can utilize the device to tighten the loose knot without the threat of impaling their hand into one or more hooks associated with the terminal tackle. The angler can maintain the device ready-for-use by removing the hook from the device and allowing the device to remain affixed to the angler's body. Subsequently, the angler can rapidly change hooks without requiring tools or equipment which might be stowed in a tackle box or boat storage locker.

In accordance with a particular embodiment, the device 100 described in accordance with one or more of the embodiments herein can be used when teaching youth anglers. More specifically, the youth angler can be instructed how to effectively and safely secure a hook to fishing line using the device described herein.

### Embodiment 1

A method of using a fishing accessory comprising: moving a terminal tackle engagement portion of the fishing accessory from a stored position to a terminal tackle engagement position; with the terminal tackle engagement portion in the terminal tackle engagement position, coupling a terminal tackle to the terminal tackle engagement portion; moving the terminal tackle engagement portion from the terminal tackle engagement position to a cinching position; and applying cinching force to the terminal tackle through the terminal tackle engagement portion.

### Embodiment 2

The method of claim 1, wherein the cinching position is disposed in an area associated with fingers of an angler.

### Embodiment 3

The method of claim 1, wherein moving the terminal tackle engagement portion from the stored position to the terminal tackle position is performed by rotating the terminal tackle engagement portion.

### Embodiment 4

The method of claim 1, wherein the fishing accessory is configured to be coupled to an angler.

### Embodiment 5

The method of claim 1, further comprising tying a knot between the terminal tackle and a fishing line prior to coupling the terminal tackle to the terminal tackle engagement portion.

### Embodiment 6

The method of claim 1, further comprising releasing the terminal tackle from the terminal tackle engagement portion, wherein releasing is performed by rotating the terminal tackle engagement portion.

### Embodiment 7

The method of claim 1, further comprising cutting excess fishing line with the terminal tackle engagement portion and returning the terminal tackle engagement portion to the stored position.

### Embodiment 8

A method of using a fishing accessory comprising: moving a terminal tackle engagement portion of the fishing accessory from a stored position on an angler's wrist to a cinching position; coupling a terminal tackle to the terminal tackle engagement portion; and applying cinching force to the terminal tackle through the terminal tackle engagement portion.

### Embodiment 9

The method of claim 8, wherein coupling the terminal tackle to the terminal tackle engagement portion is performed prior to moving the terminal tackle engagement portion to the cinching position.

### Embodiment 10

The method of claim 8, wherein the terminal tackle engagement portion is coupled with a body engagement portion of the fishing accessory, and wherein moving the terminal tackle engagement portion from the stored position to the cinching position comprises increasing a distance between the terminal tackle engagement portion and the body engagement portion.

### Embodiment 11

The method of claim 10, wherein the terminal tackle engagement portion and body engagement portion are dynamically coupled together.

### Embodiment 12

The method of claim 10, wherein the terminal tackle engagement portion is coupled to the body engagement portion through a retractor.

### Embodiment 13

The method of claim 8, wherein the fishing accessory remains coupled to the angler's wrist when the terminal tackle engagement portion is in the stored position and the cinching position.

### Embodiment 14

The method of claim 8, wherein coupling the terminal tackle to the terminal tackle engagement portion is performed by coupling the terminal tackle engagement portion with a hook of the terminal tackle.

### Embodiment 15

The method of claim 8, wherein applying the cinching force to the terminal tackle is performed with the angler's hands in one or more safe zones relative to the terminal tackle.

### Embodiment 16

The method of claim 8, further comprising releasing the terminal tackle from the terminal tackle engagement portion by rotating the terminal tackle engagement portion.

### Embodiment 17

A fishing accessory configured to be selectively coupled with a terminal tackle during a knot cinching operation, wherein the fishing accessory is configured to be stored on an angler's wrist.

### Embodiment 18

The fishing accessory of claim 17, wherein the fishing accessory comprises a terminal tackle engagement portion dynamically coupled with a body engagement portion.

### Embodiment 19

The fishing accessory of claim 18, wherein the terminal tackle engagement portion is coupled to the body engagement portion by a retractor.

### Embodiment 20

The fishing accessory of claim 19, wherein the retractor is coupled to the body engagement portion and configured to remain adjacent to the angler's wrist.

### Embodiment 21

The fishing accessory of claim 18, wherein the terminal tackle engagement portion comprises: an area configured to receive a hook during knot cinching operations; and a transverse hook passage configured to permit engagement of the hook with the area.

### Embodiment 22

The fishing accessory of claim 18, wherein the terminal tackle engagement portion comprises a cutting element configured to cut excess fishing line.

### Embodiment 23

The fishing accessory of claim 22, wherein the cutting element comprises a fixed blade.

### Embodiment 24

The fishing accessory of claim 22, wherein the cutting element comprises a dynamic blade.

### Embodiment 25

The fishing accessory of claim 22, wherein the cutting element is embedded within the terminal tackle engagement portion.

### Embodiment 26

The fishing accessory of claim 18, wherein the fishing accessory comprises a terminal tackle engagement portion configured to permit an angler to attach a terminal tackle to the terminal tackle engagement portion.

### Embodiment 27

The fishing accessory of claim 26, wherein the terminal tackle engagement portion is coupled with the body engagement portion.

### Embodiment 28

The fishing accessory of claim 26, wherein the terminal tackle engagement portion is configured to support the terminal tackle engagement portion after the terminal tackle engagement portion is moved from the stored position and prior to moving the terminal tackle engagement portion to a cinching position.

### Embodiment 29

A fishing accessory comprising an area configured to receive a terminal tackle during a knot cinching operation, wherein the area comprises a transverse hook passage configured to permit engagement of a hook of the terminal tackle with the area.

### Embodiment 30

The fishing accessory of claim 29, wherein the area is disposed within a body of the fishing accessory, and wherein the body comprises an angler grippable area.

### Embodiment 31

The fishing accessory of claim 29, wherein the area is disposed within a body of the fishing accessory, and wherein the area extends between opposite surfaces of the body.

### Embodiment 32

The fishing accessory of claim 29, wherein the area is disposed within a terminal tackle engagement portion of the fishing accessory, and wherein the terminal tackle engagement portion is dynamically coupled with a body engagement portion of the fishing accessory.

### Embodiment 33

The fishing accessory of claim 32, wherein the terminal tackle engagement portion is dynamically coupled with the body engagement portion at a location adjacent to first end of the terminal tackle engagement portion, and wherein the area is disposed adjacent to a second end of the terminal tackle engagement portion.

### Embodiment 34

A fishing accessory comprising a terminal tackle engagement portion dynamically coupled with an adjustable band, wherein the terminal tackle engagement portion is configured to be coupled with a terminal tackle during a knot cinching operation.

### Embodiment 35

The fishing accessory of claim 34, wherein the adjustable band is infinitely adjustable.

### Embodiment 36

The fishing accessory of claim 34, wherein the adjustable band comprises a hook and loop fastener.

### Embodiment 37

The fishing accessory of claim 34, wherein the adjustable band is coupled with the terminal tackle engagement portion through a retractor.

### Embodiment 38

The fishing accessory of claim 37, wherein the retractor is configured to remain at a relatively fixed location relative to an angler's body during the knot cinching operation.

### Embodiment 39

The fishing accessory of claim 34, wherein the terminal tackle engagement portion comprises a cutting element.

### Embodiment 40

The fishing accessory of claim 39, wherein the cutting element is embedded within a body of the terminal tackle engagement portion.

### Embodiment 41

The fishing accessory of claim 34, wherein the terminal tackle engagement portion has a stored position, a cinching position, and a terminal tackle engagement position, and wherein all positions are different from one another.

### Embodiment 42

A fishing accessory comprising: a fishing tool; and a terminal tackle engagement portion coupled with the fishing tool, wherein the terminal tackle engagement portion is configured to be selectively coupled with a terminal tackle during a knot cinching operation.

### Embodiment 43

The fishing accessory of claim 42, wherein the fishing tool comprises a rod holder.

### Embodiment 44

The fishing accessory of claim 43, wherein the rod holder is configured to be coupled to an angler's body.

### Embodiment 45

The fishing accessory of claim 42, wherein the fishing tool comprises a net, a fishing rod, a reel, waders, a hat, fishing apparel, a knife, a gaffe, a harpoon, a boat accessory, or any combination thereof.

### Embodiment 46

The fishing accessory of claim 42, wherein the terminal tackle engagement portion comprises a cutting element.

### Embodiment 47

The fishing accessory of claim 42, wherein the terminal tackle engagement portion is dynamically coupled to the fishing tool.

### Embodiment 48

The fishing accessory of claim 42, wherein the terminal tackle engagement portion is configured to be selectively coupled to the fishing tool.

### Embodiment 49

A fishing accessory comprising: a body engagement portion including a base; and a terminal tackle engagement portion coupled to the base and having a stored orientation, as measured with respect to the base, and an in-use orientation, as measured with respect to the base when not stored, different than the stored orientation.

### Embodiment 50

The fishing accessory of claim 49, wherein the in-use orientation is rotationally offset from the stored orientation by an angle in a range of 1° and 270°, in a range of 5° and 225°, in a range of 10° and 205°, in a range of 20° and 195°, or in a range of 60° and 180°.

### Embodiment 51

The fishing accessory of claim 49, wherein the in-use orientation corresponds with an orientation of the terminal tackle engagement portion during a knot cinching operation.

### Embodiment 52

The fishing accessory of claim 49, wherein the terminal tackle engagement portion further comprises a terminal tackle engagement orientation where the terminal tackle engagement portion is configured to receive a terminal tackle, and wherein the terminal tackle engagement orientation is different than at least one of the stored orientation and the in-use orientation.

### Embodiment 53

The fishing accessory of claim 52, wherein the terminal tackle engagement orientation is at an angle between the stored orientation and the in-use orientation.

### Embodiment 54

The fishing accessory of claim 52, wherein the terminal tackle engagement orientation is approximately-equally rotationally offset from the stored orientation and the in-use orientation.

### Embodiment 55

The fishing accessory of claim 49, wherein the base comprises a major surface configured to be parallel with a major surface of the terminal tackle engagement portion when the terminal tackle engagement portion is in the stored orientation.

### Embodiment 56

The fishing accessory of claim 49, wherein the terminal tackle engagement portion is configured to be selectively coupled to the body engagement portion by a magnet.

### Embodiment 57

A fishing accessory configured to be coupled to an angler's body, the fishing accessory comprising: a body engagement portion configured to selectively couple the fishing accessory to the angler's body; and a terminal tackle engagement comprising a body, wherein the body is coupled to the body engagement portion at a first location, and wherein the body is configured to be selectively coupled with a terminal tackle during a knot cinching operation at a second location spaced apart entirely from the first location.

### Embodiment 58

The fishing accessory of claim 57, wherein the first and second locations are on opposite ends of the body.

### Embodiment 59

A fishing accessory including a terminal tackle engagement portion comprising: a body defining a terminal tackle engagement area configured to be selectively coupled with a terminal tackle during a knot cinching operation; and a cutting surface configured to cut excess fishing line, wherein the terminal tackle engagement portion is free of moving parts associated with the knot cinching operation and a cutting operation associated with the cutting surface.

### Embodiment 60

The fishing accessory of claim 59, wherein the cutting surface is embedded within a body of the terminal tackle engagement portion.

### Embodiment 61

The fishing accessory of claim 59, wherein the terminal tackle engagement portion is coupled with a body engagement portion configured to selectively couple the fishing accessory to an angler's body.

### Embodiment 62

The fishing accessory of claim 61, wherein the body engagement portion is configured to be selectively coupled to a wrist of the angler's body.

### Embodiment 63

The fishing accessory of claim 61, wherein the body engagement portion comprises adjustable parts.

### Embodiment 64

The fishing accessory of claim 59, wherein the terminal tackle engagement portion is dynamically coupled with a body engagement portion configured to selectively couple the fishing accessory to an angler's body.

### Embodiment 65

The fishing accessory of claim 59, wherein the cutting surface is spaced apart from the terminal tackle engagement area.

### Embodiment 66

The fishing accessory of claim 59, wherein the terminal tackle engagement area is configured to selectively engage with a treble hook of the terminal tackle.

### Embodiment 67

The fishing accessory of claim 59, wherein the terminal tackle engagement area comprises a transverse hook passage configured to permit engagement of a hook of the terminal tackle in the terminal tackle engagement area.

### Embodiment 68

The fishing accessory of claim 59, wherein the body comprises indicia.

### Embodiment 69

The fishing accessory of claim 68, wherein the indicia is raised.

### Embodiment 70

The fishing accessory of claim 59, wherein the body comprises a magnet.

### Embodiment 71

The fishing accessory of claim 70, wherein the magnet is disposed adjacent to the cutting surface.

### Embodiment 72

A method of using a fishing accessory comprising: attaching a fishing rod to a rod holder of the fishing accessory; using a terminal tackle engagement portion of the fishing accessory to perform a knot cinching operation; and removing the fishing rod from the rod holder.

### Embodiment 73

The method of claim 72, wherein the fishing rod holder comprises a rotatable rod holder configured to hold the fishing rod within a range of rotatable angles.

### Embodiment 74

The method of claim 72, wherein the terminal tackle engagement portion is dynamically coupled with the rod holder.

### Embodiment 75

The method of claim 74, wherein the terminal tackle is coupled with the rod holder by a retractable line.

### Embodiment 76

The method of claim 72, wherein the terminal tackle engagement portion is configured to be used for the knot cinching operation while the fishing rod is attached to the rod holder.

### Embodiment 77

The method of claim 72, wherein using the terminal tackle engagement portion is performed after attaching the fishing rod to the rod holder.

### Embodiment 78

The method of claim 72, wherein attaching the fishing rod to the rod holder is performed by engaging an attachment portion of the fishing rod with the rod holder.

### Embodiment 79

The method of claim 78, wherein the attachment portion is removably attached to the fishing rod.

### Embodiment 80

The method of claim 78, wherein the attachment portion comprises an integral part of the fishing rod.

### Embodiment 81

The method of claim 72, wherein the fishing accessory is configured to be coupled to an angler's body prior to attaching the fishing rod to the rod holder.

### Embodiment 82

The method of claim 81, further comprising: repositioning the fishing accessory relative to the angler's body after attaching the fishing rod to the rod holder.

### Embodiment 83

The method of claim 82, wherein repositioning the fishing accessory comprises rotating the fishing accessory around the angler's body.

### Embodiment 84

The method of claim 83, wherein repositioning is performed using a handle coupled with a waste band coupled to the fishing accessory.

### Embodiment 85

The method of claim 72, wherein the terminal tackle engagement portion is dynamically coupled with the rod holder.

### Embodiment 86

A fishing accessory configured to be selectively coupled with a terminal tackle during a knot cinching operation, wherein the fishing accessory is configured to attach to a watch or wristband of an angler.

### Embodiment 87

A fishing accessory configured to be selectively coupled with a terminal tackle during a knot cinching operation, wherein the fishing accessory is configured to attach to a hat of an angler.

### Embodiment 88

A device for fishing comprising: a wrist engagement portion adapted to be selectively secured to a wrist of a user; a hook engagement portion coupled with the wrist engagement portion and adapted to selectively engage with a hook.

### Embodiment 89

The device of embodiment 88, wherein the wrist engagement portion comprises a band extending around at least a majority of the wrist of the user.

### Embodiment 90

The device of embodiment 88, wherein the wrist engagement portion defines a circumference, and wherein the circumference of the wrist engagement portion is adjustable, such as infinitely adjustable.

### Embodiment 91

The device of embodiment 88, wherein the wrist engagement portion is adjustable, including a first circumference adapted to permit insertion of a hand of the user into the wrist engagement portion and a second circumference adapted to prevent removal of the hand of the user from the wrist engagement portion.

### Embodiment 92

The device of embodiment 91, wherein a length of the hook engagement portion increases as the circumference of the wrist engagement portion decreases.

### Embodiment 93

The device of embodiment 88, wherein the wrist engagement portion and the hook engagement portion are spaced apart by an intermediate portion, and wherein the intermediate portion and wrist engagement portion are monolithic with one another, or wherein the wrist engagement portion and the intermediate portion are coupled together.

### Embodiment 94

The device of embodiment 88, wherein the hook engagement portion is dynamically coupled to the wrist engagement portion.

### Embodiment 95

The device of embodiment 88, wherein the wrist engagement portion defines an opening adapted to receive the wrist of the user, and wherein the opening defines a tear drop shape.

### Embodiment 96

The device of embodiment 95, wherein the hook engagement portion is coupled with the wrist engagement portion at, or adjacent to, an apex of the tear drop shape.

### Embodiment 97

The device of embodiment 88, wherein the wrist engagement portion defines an opening adapted to receive the wrist of the user, and wherein the opening has a curved portion, a linear portion, or a combination thereof.

### Embodiment 98

The device of embodiment 88, wherein the wrist engagement portion comprises a padded portion.

### Embodiment 99

The device of embodiment 98, wherein the padded portion is disposed at a circumferential location of the wrist engagement portion opposite, or generally opposite, the hook engagement portion.

### Embodiment 100

The device of embodiment 98, wherein the padded portion has a diameter greater than a diameter of a non-padded portion of the wrist engagement portion.

### Embodiment 101

The device of embodiment 88, wherein the wrist engagement portion comprises an interface adapted to engage with an equipment.

### Embodiment 102

The device of embodiment 101, wherein the equipment comprises, a light, a blade, scissors, clippers, a fish grip, a camera remote, a camera, a fishing net, a mobile display device, a bait or tackle element, a paddle or oar, a rod or reel, a time keeping element, or any combination thereof.

### Embodiment 103

The device of embodiment 88, wherein the hook engagement portion defines an area adapted to receive the hook.

### Embodiment 104

The device of embodiment 88, wherein the hook engagement portion comprises a body adapted to receive the hook.

### Embodiment 105

The device of embodiment 104, wherein the body comprises a bottle opener.

### Embodiment 106

The device of embodiment 104, wherein the body comprises a whistle.

### Embodiment 107

The device of embodiment 104, wherein the body comprises a clipper, scissors, a knife, a light, a fish grip, a camera remote, a camera, a fishing net, a mobile display device, a bait or tackle element, a paddle or oar, a rod or reel, a time keeping element, or any combination thereof.

### Embodiment 108

The device of embodiment 104, wherein the body comprises a resilient material such as a metal, an alloy, a polymer, or any combination thereof.

### Embodiment 109

The device of embodiment 17, wherein the hook engagement portion further comprises an intermediate portion disposed between the body and the wrist engagement portion.

### Embodiment 110

The device of embodiment 109, wherein the intermediate portion is monolithic with the wrist engagement portion.

### Embodiment 111

The device of embodiment 109, wherein the intermediate portion is dynamically coupled to the body.

### Embodiment 112

The device of embodiment 104, wherein the body defines a retention feature adapted to prevent slipping of the hook from the body.

### Embodiment 113

The device of embodiment 104, wherein the body defines an opening adapted to receive the hook, and wherein the opening has a dimension at least 1.01 times a thickness of the hook to be received.

### Embodiment 114

The device of embodiment 104, wherein the hook engagement portion is selectively engageable with a finger of the user.

### Embodiment 115

The device of embodiment 114, wherein the hook engagement portion is adapted to be coupled with the finger of the user when not engaged with the hook.

### Embodiment 116

The device of embodiment 114, wherein at least a portion of the hook engagement portion is adapted to contact a palm of the hand of the user when the hook engagement portion is coupled with the finger.

### Embodiment 117

The device of embodiment 104, wherein the body of the hook engagement portion is adapted to be coupled with a rod.

### Embodiment 118

The device of embodiment 117, wherein the body of the hook engagement portion is adapted to be coupled with a reel seat of the rod.

### Embodiment 119

The device of embodiment 117, wherein the body of the hook engagement portion is adapted to be coupled with a finger grip of the rod.

### Embodiment 120

The device of embodiment 117, wherein at least a portion of the hook engagement portion is adapted to be disposed between the rod and the wrist of the user when the body of the hook engagement portion is coupled with the rod.

### Embodiment 121

The device of embodiment 88, wherein the hook engagement portion is adapted to define a first length when engaged with and biasing the hook and a second length when disengaged with the hook, and wherein the first length is greater than the second length.

### Embodiment 122

The device of embodiment 88, wherein the hook engagement portion comprises an elastic element adapted to bias at least a portion of the hook engagement portion toward the wrist engagement portion.

### Embodiment 123

The device of embodiment 88, wherein the wrist engagement portion comprises a textile, wherein the hook engagement portion comprises a textile, or a combination thereof.

### Embodiment 124

The device of embodiment 88, wherein the hook engagement portion is adapted to be closer to a palm of the user than a backside of the hand of the user.

### Embodiment 125

A method of fishing comprising: tying a fishing line to a terminal tackle comprising a hook; engaging the hook with a hook engagement portion coupled with a wrist engagement portion coupled with a wrist of a user; and pulling at least one of the fishing line and wrist away from the other of the fishing line and wrist.

### Embodiment 126

The method of embodiment 125, wherein pulling the fishing line and wrist away from the other is performed with the hook disposed between the fishing line and the wrist.

### Embodiment 127

The method of embodiment 125, further comprising: removing the hook from the hook engagement portion; and maintaining the wrist engagement portion on the wrist of the user after removing the hook from the hook engagement portion.

### Embodiment 128

The method of embodiment 127, further comprising coupling the hook engagement portion with the rod.

### Embodiment 129

The method of embodiment 128, wherein the hook engagement portion is adapted to be coupled with a finger grip of the rod.

### Embodiment 130

The method of embodiment 128, further comprising casting the hook with the hook engagement portion coupled with the rod.

### Embodiment 131

The method of embodiment 130, wherein a force applied on the cast is greater with the hook engagement portion engaged with the rod as compared to when the hook engagement portion is disengaged with the rod, as measured with a same input casting force applied by the user.

### Embodiment 132

The method of embodiment 127, further comprising coupling the hook engagement portion with a finger of the user.

### Embodiment 133

The method of embodiment 127, wherein at least a portion of the hook engagement portion is adapted to be disposed between a hand of the user and a rod.

### Embodiment 134

The method of embodiment 125, further comprising: inserting the wrist into the wrist engagement portion; and adjusting a size of the wrist engagement portion.

### Embodiment 135

The method of embodiment 134, wherein adjusting the size of the wrist engagement portion is performed prior to engaging the hook with the hook engagement portion.

### Embodiment 136

The method of embodiment 134, wherein adjusting the size of the wrist engagement portion is performed along an infinite adjustment length.

### Embodiment 137

The method of embodiment 125, wherein tying the fishing line to the terminal tackle is performed by loosely tying the fishing line to the terminal tackle.

### Embodiment 138

The method of embodiment 125, wherein pulling the fishing line is performed with a first arm and pulling the wrist is performed with a second arm different than the first arm.

### Embodiment 139

The method of embodiment 125, wherein engaging the hook with the hook engagement portion is performed such that the hook engagement portion is disposed closer to the palm of the hand than a backside of the hand.

### Embodiment 140

The method of embodiment 125, further comprising adjusting a length of the hook engagement portion prior to engaging the hook with the hook engagement portion.

### Embodiment 141

The method of embodiment 125, wherein pulling the fishing line and wrist in directions generally opposite one another is performed with a first arm holding the fishing line and a second arm holding the wrist engagement portion, and wherein the fingers of the second arm are spaced apart from a device comprising the wrist engagement portion and the hook engagement portion during pulling.

### Embodiment 142

The method of embodiment 125, wherein engaging the hook with the hook engagement portion is performed prior to tying the fishing line to the terminal tackle.

### Embodiment 143

The method of embodiment 125, wherein engaging the hook with the hook engagement portion is performed after tying the fishing line to the terminal tackle.

### Embodiment 144

A device adapted to grip a fishhook and extend between the fishhook and a wrist of a user when the user tightens the fish hook with a fishing line.

### Embodiment 145

The device of embodiment 144, wherein the device is finger-free.

### Embodiment 146

The device of embodiment 144, wherein the device is adapted to remain coupled with the wrist of the user when disengaged with the fishhook.

### Embodiment 147

The device of embodiment 144, wherein the device is selectively engageable with a finger grip of a rod.

### Embodiment 148

The device of embodiment 147, wherein a force required to cast X-distance is less when the device is engaged with the finger grip as compared to when the device is disengaged with the finger grip.

### Embodiment 149

A device adapted to enhance a cast distance of a user comprising: a wrist engagement portion adapted to be disposed around a wrist of the user; and a rod engagement portion coupled with the wrist engagement portion, wherein the rod engagement portion is adapted to selectively couple with a finger grip of the rod.

### Embodiment 150

The device of embodiment 149, wherein the rod engagement portion is adapted to engage with a fishhook.

### Embodiment 151

The device of embodiment 150, wherein the rod engagement portion is adapted to pull on the fishhook when a user selectively tightens a knot securing the fishhook to a fishing line.

### Embodiment 152

The device of embodiment 149, wherein a force required to cast X-distance is less when the rod engagement portion is engaged with the finger grip as compared to when the rod engagement portion is disengaged with the finger grip.

### Embodiment 153

The device of embodiment 149, wherein the rod engagement portion comprises a selective lock feature adapted to prevent accidental disconnection between the rod engagement portion and the rod.

### Embodiment 154

A finger grip cover for a fishing rod.

### Embodiment 155

The finger grip cover of embodiment 154, wherein the finger grip cover is adapted to engage with the device of any one of embodiments 144-153.

1. A method of using a fishing accessory comprising:
moving a terminal tackle engagement portion of the fishing accessory from a stored position to a terminal tackle engagement position;
with the terminal tackle engagement portion in the terminal tackle engagement position, coupling a terminal tackle to the terminal tackle engagement portion;
moving the terminal tackle engagement portion from the terminal tackle engagement position to a cinching position; and
applying cinching force to the terminal tackle through the terminal tackle engagement portion.

2. The method of claim 1, wherein moving the terminal tackle engagement portion from the stored position to the terminal tackle position is performed by rotating the terminal tackle engagement portion.

3. The method of claim 1, further comprising tying a knot between the terminal tackle and a fishing line prior to coupling the terminal tackle to the terminal tackle engagement portion.

4. The method of claim 1, further comprising cutting excess fishing line with the terminal tackle engagement portion and returning the terminal tackle engagement portion to the stored position.

5. The method of claim 1, further comprising releasing the terminal tackle from the terminal tackle engagement portion by rotating the terminal tackle engagement portion.

6. The method of claim 1, wherein the fishing accessory is configured to be worn on an angler's wrist.

7. A fishing accessory configured to be selectively coupled with a terminal tackle during a knot cinching operation, wherein the fishing accessory is configured to be stored on an angler's wrist.

8. The fishing accessory of claim 7, wherein the fishing accessory comprises a terminal tackle engagement portion dynamically coupled with a body engagement portion by a retractor.

9. The fishing accessory of claim 8, wherein the terminal tackle engagement portion comprises:
an area configured to receive a hook during knot cinching operations; and
a transverse hook passage configured to permit engagement of the hook with the area.

10. The fishing accessory of claim 8, wherein the terminal tackle engagement portion comprises a cutting element configured to cut excess fishing line.

11. The fishing accessory of claim 10, wherein the cutting element comprises a fixed blade.

12. A fishing accessory including a terminal tackle engagement portion comprising:
a body defining a terminal tackle engagement area configured to be selectively coupled with a terminal tackle during a knot cinching operation; and
a cutting surface configured to cut excess fishing line,
wherein the terminal tackle engagement portion is essentially free of moving parts associated with the knot cinching operation and a cutting operation associated with the cutting surface.

13. The fishing accessory of claim 12, wherein the cutting surface is at least partially embedded within a body of the terminal tackle engagement portion.

14. The fishing accessory of claim 12, wherein the terminal tackle engagement portion is coupled with a body engagement portion configured to selectively couple the fishing accessory to an angler's body.

15. The fishing accessory of claim 14, wherein the body engagement portion is configured to be selectively coupled to a wrist of the angler's body.

16. The fishing accessory of claim 15, wherein the body engagement portion comprises a wrist band.

17. The fishing accessory of claim 12, wherein the terminal tackle engagement area comprises a transverse hook passage configured to permit engagement of a hook of the terminal tackle in the terminal tackle engagement area.

18. The fishing accessory of claim 12, wherein the body defines a terminal tackle engagement position configured to suitably position the terminal tackle engagement portion when selectively coupling with the terminal tackle.

19. The fishing accessory of claim 12, wherein the fishing accessory comprises a rod holding portion configured to receive and support a fishing rod during the knot cinching operation.

20. The fishing accessory of claim 12, wherein the terminal tackle engagement portion is selectively coupled to a body engagement portion of the fishing accessory by a magnet.
